(19) United States
(12) Patent Application Publication
(10) Pub. No.: US 2024/0208503 A1
(43) Pub. Date: Jun. 27, 2024

(54) DRIVING SUPPORT DEVICE

(71) Applicant: TOYOTA JIDOSHA KABUSHIKI KAISHA, Toyota-shi (JP)

(72) Inventor: Hiroki Aikawa, Ebina-shi (JP)

(73) Assignee: TOYOTA JIDOSHA KABUSHIKI KAISHA, Toyota-shi (JP)

(21) Appl. No.: 18/472,731

(22) Filed: Sep. 22, 2023

(30) Foreign Application Priority Data
Dec. 23, 2022 (JP) 2022-206960

(51) Int. Cl. B60W 30/16; B60W 30/18

(52) U.S. Cl. CPC B60W 30/16; B60W 30/18163; B60W 2540/18; B60W 2540/20; B60W 2552/05; B60W 2554/802; B60W 2720/106; B60W 2754/30

(57) ABSTRACT

The driving support device includes a deceleration control unit, a branch path detection unit, an operation state acquisition unit, and a steering state acquisition unit. The deceleration control unit determines whether the driver intends to change the path in the branch path based on the operation state of the direction indicator and the steering state of the steering wheel, when the deceleration control unit detects that a branch path exists in front of the host vehicle during execution of the deceleration control of the host vehicle with respect to the preceding vehicle, and when the driver determines that there is an intention to change the branch path, the deceleration control of the host vehicle with respect to the preceding vehicle is ended.

### CROSS-REFERENCE TO RELATED APPLICATION

This application claims priority to Japanese Patent Application No. 2022-206960 filed on Dec. 23, 2022, incorporated herein by reference in its entirety.

### BACKGROUND

### 1. Technical Field

The present disclosure relates to a driving support device.

### 2. Description of Related Art

As a conventional driving support device, for example, a technique described in Japanese Patent No. 5776702 (JP 5776702 B) is known. In the driving support device described in JP 5776702 B, when a turn signal is in operation and a steering angle is not equal to or greater than a threshold value, the deceleration control of an own vehicle is temporarily suppressed. Further, when the turn signal is in operation, the steering angle is equal to or greater than the threshold value, and there is no vehicle in an overtaking lane, the deceleration control of the own vehicle is stopped.

### SUMMARY

However, in the above-described conventional technique, when a driver of the own vehicle performs an operation of a turn signal switch and a steering wheel in order to change a route of the own vehicle to a branch path, there is a possibility that appropriate deceleration control is not performed, and driving support that is not intended by the driver is performed.

An object of the present disclosure is to provide a driving support device capable of performing driving support intended by the driver when the own vehicle changes the route to the branch path.

One aspect of the present disclosure is a driving support device for supporting driving of a vehicle, and includes:
an inter-vehicle distance detection unit for detecting an inter-vehicle distance between the own vehicle and a preceding vehicle present in front of the own vehicle;
a deceleration control unit for performing deceleration control of the own vehicle with respect to the preceding vehicle based on the inter-vehicle distance detected by the inter-vehicle distance detection unit;
a branch path detection unit for detecting whether a branch path is present in front of the own vehicle;
an operation state acquisition unit for acquiring an operation state of a turn signal of the own vehicle; and
a steering state acquisition unit for acquiring a steering state of a steering wheel of the own vehicle operated by a driver of the own vehicle.
The deceleration control unit determines whether the driver intends to change a route to the branch path based on the operation state of the turn signal acquired by the operation state acquisition unit and the steering state of the steering wheel acquired by the steering state acquisition unit when the branch path detection unit detects that the branch path is present in front of the own vehicle while the deceleration control unit executes the deceleration control of the own vehicle with respect to the preceding vehicle, and terminates the deceleration control of the own vehicle with respect to the preceding vehicle when determination is made that the driver intends to change the route to the branch path.

The deceleration control unit may determine that the driver intends to change the route to the branch path when a direction indicated by the turn signal and a steering direction of the steering wheel are the same as a branch direction of the branch path.

When a steering amount of the steering wheel is equal to or greater than a predetermined threshold value, the deceleration control unit may determine that the driver intends to change the route to the branch path.

According to the present disclosure, it is possible to perform driving support intended by the driver when the own vehicle changes the route to the branch path.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration of a driving support device according to an embodiment of the present disclosure;

FIG. 2 is a flowchart showing a procedure of a deceleration control determination process executed by the deceleration control determination unit shown in FIG. 1;

FIG. 3A is a conceptual diagram showing a state in which the subject vehicle changes the route to a branch road;

FIG. 3B is another conceptual diagram showing how the vehicle changes its course to a branch;

FIG. 4 is a conceptual diagram showing a state in which the subject vehicle changes the route to a branch road branched and connected to a curved road; and

FIG. 5 is a conceptual diagram illustrating a state in which the own vehicle changes a route to a branch road branched and connected to a right traveling lane.

### DETAILED DESCRIPTION OF EMBODIMENTS

Hereinafter, embodiments of the present disclosure will be described in detail with reference to the drawings. In the drawings, the same or equivalent elements are denoted by the same reference numerals, and redundant description will be omitted.

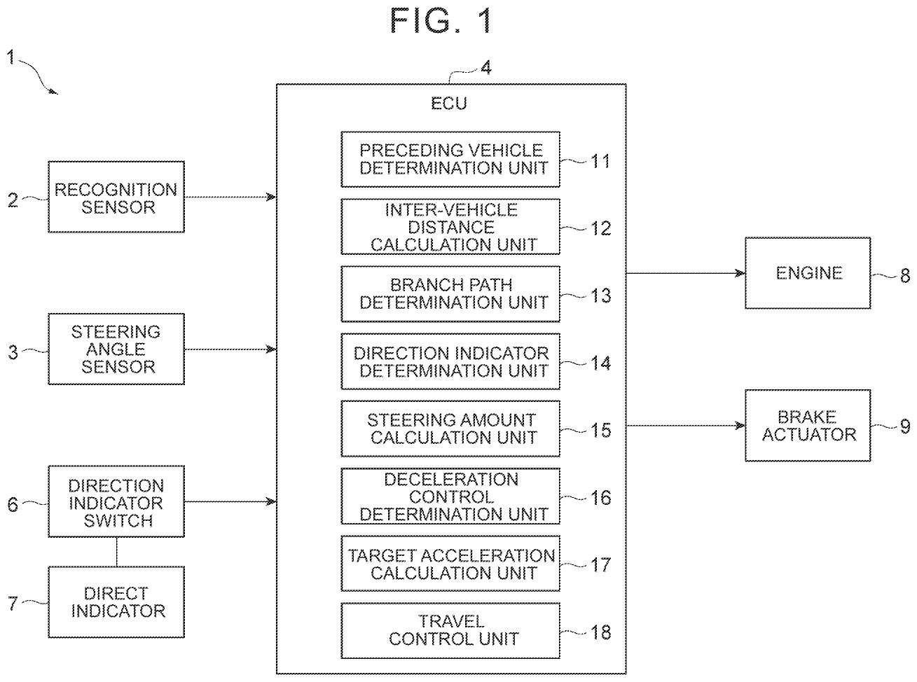

FIG. 1 is a block diagram illustrating a configuration of a driving support device according to an embodiment of the present disclosure. In FIG. 1, a driving support device 1 of the present embodiment is mounted on a vehicle having an automatic driving function. The driving support device 1 performs driving support such as following traveling in which the inter-vehicle distance is kept constant while traveling on an expressway, for example.

The driving support device 1 includes a recognition sensor 2, a steering angle sensor 3, and an ECU (Electronic Control Unit) 4.

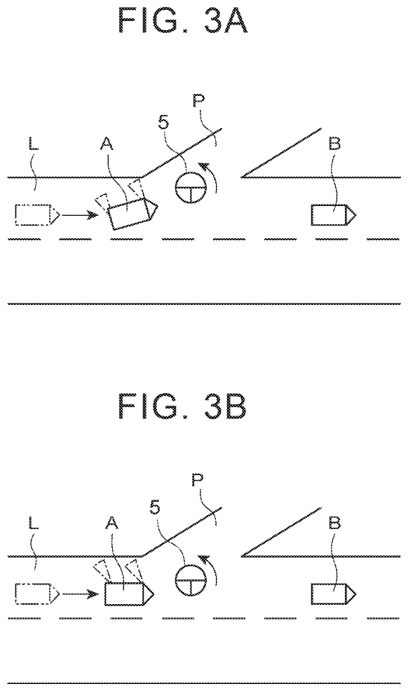

The recognition sensor 2 is a sensor that recognizes an area including the front of the own vehicle A (refer to FIGS. 3A and 3B). As the recognition sensor 2, a laser sensor such as a LiDAR (Light Detection and Ranging) that irradiates a region including the front of the own vehicle A with a laser and receives reflected light of the laser, or a camera that captures an image of a region including the front of the own vehicle A is used.

The steering angle sensor 3 is a sensor that detects a steering angle of the steering wheel 5 (refer to FIGS. 3A and 3B) operated by the driver of the own vehicle A.

ECU 4 includes a CPU, RAM, ROM, an input/output interface, and the like. ECU 4 includes a preceding vehicle determination unit 11, an inter-vehicle distance calculation unit 12, a branch path determination unit 13, a direction indicator determination unit 14, a steering amount calculation unit 15, a deceleration control determination unit 16, a target acceleration calculation unit 17, and a travel control unit 18.

The preceding vehicle determination unit 11 determines the presence or absence of the preceding vehicle B (refer to FIGS. 3A and 3B) existing in front of the own vehicle A based on the detected data of the recognition sensor 2. Specifically, the preceding vehicle determination unit 11 determines whether or not the preceding vehicle B that is the target of the deceleration control of the own vehicle A is present in the traveling lane L on which the own vehicle A is traveling. Examples of the preceding vehicle B that is the target of the deceleration control of the own vehicle A include a vehicle traveling at a very low speed in a stopped vehicle, a traffic jam, or the like.

When the preceding vehicle determination unit 11 determines that the preceding vehicle B is present in front of the own vehicle A, the inter-vehicle distance calculation unit 12 calculates the inter-vehicle distance between the own vehicle A and the preceding vehicle B based on the detection data of the recognition sensor 2. The inter-vehicle distance calculation unit 12 cooperates with the recognition sensor 2 and the preceding vehicle determination unit 11 to constitute an inter-vehicle distance detection unit that detects an inter-vehicle distance between the own vehicle A and the preceding vehicle B.

The branch path determination unit 13 detects the presence or absence of a branch path P (refer to FIGS. 3A and 3B) existing in front of the own vehicle A based on the detected data of the recognition sensor 2. The branch path P is branched and connected to a traveling lane L on the left side of the expressway. The branch path P is a road towards the exit interchange, junction, service area or parking area of the highway. The branch path determination unit 13 cooperates with the recognition sensor 2 to constitute a branch path detection unit that detects whether or not the branch path P exists in front of the own vehicle A.

The direction indicator determination unit 14 determines whether or not the direction indicator 7 is activated based on an operation signal of the direction indicator switch 6 operated by the driver of the own vehicle A. The direction indicator determination unit 14 constitutes an operation state acquisition unit that acquires an operation state of the direction indicator 7.

The steering amount calculation unit 15 calculates the steering amount of the steering wheel 5 operated by the driver of the own vehicle A based on the detection value of the steering angle sensor 3. The steering amount calculation unit 15 cooperates with the steering angle sensor 3 to constitute a steering state acquisition unit that acquires a steering state of the steering wheel 5.

The deceleration control determination unit 16 determines whether or not to perform the deceleration control of the own vehicle A with respect to the preceding vehicle B based on the calculation result of the inter-vehicle distance calculation unit 12, the determination result of the branch path determination unit 13, the determination result of the direction indicator determination unit 14, and the calculation result of the steering amount calculation unit 15. The determination processing by the deceleration control determination unit 16 will be described in detail later.

The target acceleration calculation unit 17 calculates the target acceleration of the own vehicle A based on the inter-vehicle distance between the own vehicle A and the preceding vehicle B. When the deceleration control determination unit 16 determines that the deceleration control of the own vehicle A with respect to the preceding vehicle B is to be performed, the target acceleration calculation unit 17 calculates a negative target acceleration (target deceleration) corresponding to the inter-vehicle distance between the own vehicle A and the preceding vehicle B.

The travel control unit 18 controls the engine 8 and the brake actuator 9 to cause the own vehicle A to travel in accordance with the target acceleration calculated by the target acceleration calculation unit 17.

Here, the deceleration control determination unit 16, the target acceleration calculation unit 17, and the travel control unit 18 constitute a deceleration control unit that performs deceleration control of the own vehicle A with respect to the preceding vehicle B based on the inter-vehicle distance detected by the inter-vehicle distance detection unit.

During the execution of the deceleration control of the own vehicle A with respect to the preceding vehicle B, when the branch path detection unit detects that the branch path P is present in front of the own vehicle A, the deceleration control unit determines whether or not the driver intends to change the path in the branch path P based on the operating state of the direction indicator 7 acquired by the operation state acquisition unit and the steering state of the steering wheel 5 acquired by the steering state acquisition unit. The deceleration control unit terminates the deceleration control of the own vehicle A with respect to the preceding vehicle B when the driver determines that there is an intention to change the route to the branch path P.

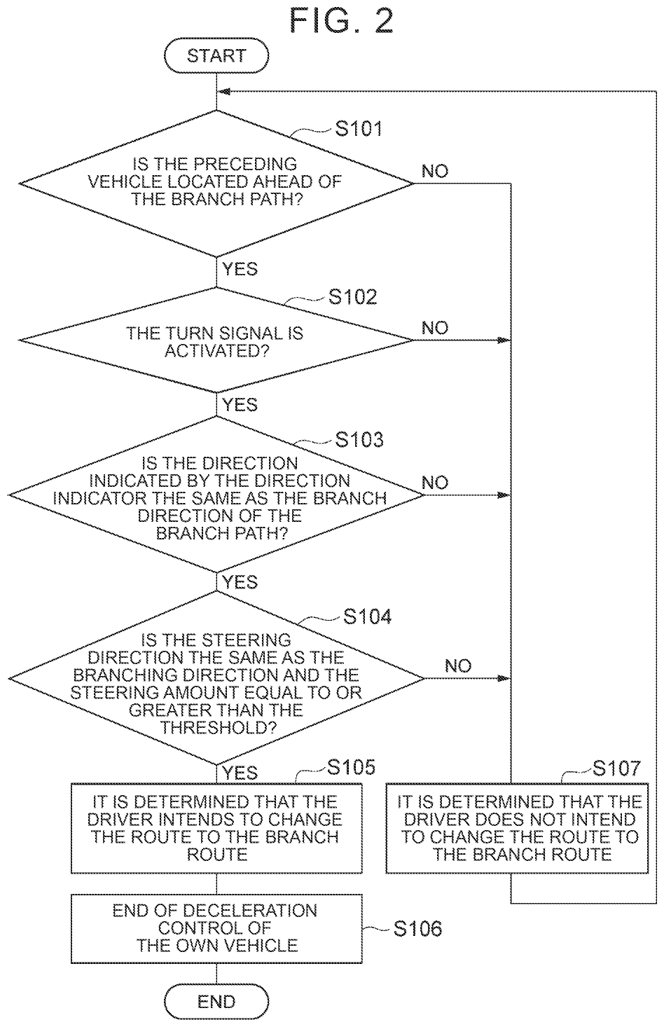

FIG. 2 is a flowchart showing a procedure of a deceleration control determination process executed by the deceleration control determination unit 16. The present processing is processing for determining whether or not to end the deceleration control of the own vehicle A after the execution of the deceleration control of the own vehicle A with respect to the preceding vehicle B is started. The preceding vehicle B is a stopped vehicle or a low-speed traveling vehicle.

In FIG. 2, the deceleration control determination unit 16 first determines, based on the determination results of the preceding vehicle determination unit 11 and the branch path determination unit 13, whether or not the preceding vehicle B exists at a position ahead of the branch path P, as shown in FIGS. 3A and 3B (step S101).

When the deceleration control determination unit 16 determines that the preceding vehicle B is located at a position ahead of the branch path P, it determines whether or not the direction indicator 7 is operating based on the determination result of the direction indicator determination unit 14 (step S102).

When determining that the direction indicator 7 is operating, the deceleration control determination unit 16 determines whether the direction indicator 7 and the branch direction of the branch path P are the same based on the determination results of the direction indicator determination unit 14 and the branch path determination unit 13 (step S103).

The deceleration control determination unit 16 determines whether the steering direction of the steering wheel 5 and the branch direction of the branch path P are the same and the steering amount of the steering wheel 5 is equal to or greater than a predetermined threshold based on the calculation result of the steering amount calculation unit 15 and the determination result of the branch path determination unit 13 when it is determined that the direction of the direction indicator 7 and the branch direction of the branch path P are the same (step S104).

Here, the steering amount of the steering wheel 5 is a steering amount from the steering position of the steering wheel 5 when the own vehicle A is traveling along the traveling lane L. Therefore, when the own vehicle A is traveling along the traveling lane L, the steering amount of the steering wheel 5 is the absolute value of the steering amount of the steering wheel 5 at the steering position (the steering angle is 0 degrees) at which the steering wheel 5 is straight.

When the deceleration control determination unit 16 determines that the steering direction of the steering wheel 5 and the branching direction of the branch path P are the same and that the steering amount of the steering wheel 5 is equal to or greater than the threshold value, it determines that the driver of the own vehicle A intends to change the route to the branch path P (step S105).

Then, the deceleration control determination unit 16 terminates the deceleration control of the own vehicle A with respect to the preceding vehicle B, and outputs a signal to shift to the normal travel control with respect to the preceding vehicle B to the target acceleration calculation unit 17 (step S106). The normal travel control with respect to the preceding vehicle B is control such that the following travel is performed with respect to the preceding vehicle B.

On the other hand, when the deceleration control determination unit 16 determines that the preceding vehicle B does not exist at a position earlier than the branch path P in the procedure S101, when it is determined that the direction indicator 7 is not operated in the procedure S102, when it is determined that the direction indicating the direction indicator 7 and the branch direction of the branch path P are not the same in the procedure S103, or when it is determined that the condition that the steering direction of the steering wheel 5 and the branch direction of the branch path P are the same in the procedure S104 and the steering amount of the steering wheel 5 is not equal to or larger than the threshold value is not satisfied, it is determined that the driver of the own vehicle A does not intend to change the route to the branch path P (procedure S107). Then, the deceleration control determination unit 16 executes the above-described procedure S101 again. Therefore, the deceleration control of the own vehicle A with respect to the preceding vehicle B is continuously performed.

The deceleration control determination unit 16 may output, to the target acceleration calculation unit 17, a signal indicating that the own vehicle A is to be stopped urgently when the own vehicle A approaches the preceding vehicle B when the deceleration control of the own vehicle A with respect to the preceding vehicle B is continuously performed.

As shown in FIGS. 3A and 3B, when the branch path P is branched and connected to the left traveling lane L on which the own vehicle A is traveling and when the own vehicle A attempts to change the route from the traveling lane L to the branch path P, the driver of the own vehicle A operates the direction indicator switch 6 so that the direction indicator 7 indicates the left side and steers the steering wheel 5 to the left side.

In the conventional control process, when the deceleration control of the own vehicle A with respect to the preceding vehicle B existing at the position ahead of the branch path P is being performed, as shown in FIG. 3A, even if the left steering of the steering wheel 5 is started in order for the own vehicle A to change the route from the traveling lane L to the branch path P, the deceleration control of the own vehicle A with respect to the preceding vehicle B is continued as it is until the lap ratio between the own vehicle A and the preceding vehicle B becomes equal to or less than a predetermined value.

On the other hand, in the present embodiment, when the deceleration control of the own vehicle A with respect to the preceding vehicle B existing at the position ahead of the branch path P is being performed, as shown in FIG. 3B, the direction indicating direction of the direction indicator 7 and the branch direction of the branch path P are on the same left side, and when the left steering of the steering wheel 5 is started by a specified amount, the deceleration control of the own vehicle A with respect to the preceding vehicle B is ended. Therefore, since the deceleration of the own vehicle A is relaxed, a behavior close to an expected value of the driver is realized.

As described above, in the present embodiment, the deceleration control of the own vehicle A with respect to the preceding vehicle B is performed on the basis of the inter-vehicle distance between the own vehicle A and the preceding vehicle B, whereby the own vehicle A is appropriately decelerated with respect to the preceding vehicle B while the own vehicle A is stopped or traveling at a low speed in a traffic jam or the like. When it is detected that the branch path P exists in front of the own vehicle A during the execution of the deceleration control of the own vehicle A with respect to the preceding vehicle B, it is determined whether or not the driver of the own vehicle A intends to change the route to the branch path P based on the operating state of the direction indicator 7 and the steering state of the steering wheel 5. When it is determined that the driver intends to change the route to the branch path P, the deceleration control of the own vehicle A with respect to the preceding vehicle B is ended. Therefore, when the own vehicle A changes the route to the branch path P, unnecessary deceleration of the own vehicle A is suppressed. As a result, when the own vehicle A changes the route to the branch path P, the driving support intended by the driver is performed. As a result, the path change to the branch path P is performed in a behavior close to the intention of the driver, so that it is possible to achieve both comfort and a sense of security.

Further, in the present embodiment, when the own vehicle A changes the route to the branch path P, the driver instructs the direction corresponding to the branching direction of the branch path P by the direction indicator 7, and the driver steers the steering wheel 5 in the direction corresponding to the branching direction of the branch path P. Therefore, by determining whether or not the pointing direction of the direction indicator 7 and the steering direction of the steering wheel 5 are the same as the branching direction of the branch path P, it is accurately determined whether or not the driver intends to change the route in the branch path P.

Further, in the present embodiment, when the own vehicle A changes the route to the branch path P, the driver needs to steer the steering wheel 5 by a specified amount. Therefore, by determining whether or not the steering amount of the steering wheel 5 is equal to or greater than the threshold value, it is determined more accurately whether or not the driver intends to change the route in the branch path P.

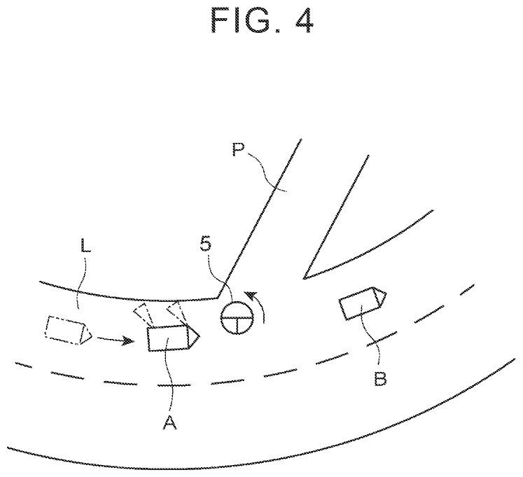

Note that the present disclosure is not limited to the above-described embodiment. For example, the branch path P is not limited to a form in which the branch path P is branched and connected to a straight road as shown in FIG. 3A and 3B, and may be branched and connected to a curved road as shown in FIG. 4. In this case, when the own vehicle A is traveling along the traveling lane L of the curved road, the steering wheel 5 is somewhat steered along the curved road, and thus the steering angle of the steering wheel 5 is larger than 0 degrees. Therefore, the amount of steering of the steering wheel 5 when the own vehicle A changes the route to the branch path P is the amount of change from the amount of steering of the steering wheel 5 when the own vehicle A travels along the traveling lane L of the curved road.

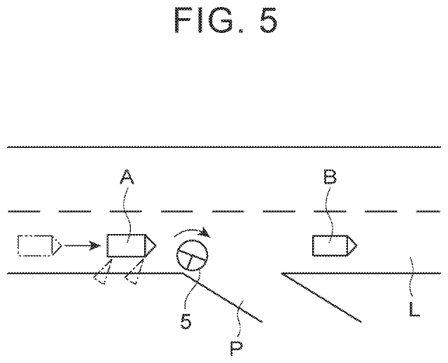

Further, in the above-described embodiment, the branch path P is branched and connected to the left traveling lane L, but the present disclosure is not limited to this configuration, and for example, as shown in FIG. 5, the branch path P may be branched and connected to the right traveling lane L.

In addition, although the above-described embodiment is the driving support device 1 that performs driving support when the own vehicle A travels on the expressway, the present disclosure is not limited to the expressway in particular, and is also applicable to a driving support device that performs driving support when traveling on a general road.

In addition, the above-described embodiment is the driving support device 1 that supports the following travel in which the distance between the own vehicle A and the preceding vehicle B is kept constant, but is not particularly limited to such a configuration. The present disclosure is also applicable to, for example, a driving support device that supports rear-end collision prevention for suppressing rear-end collision between the own vehicle A and the preceding vehicle B.

What is claimed is:

1. A driving support device for supporting driving of an own vehicle, the driving support device comprising:
an inter-vehicle distance detection unit for detecting an inter-vehicle distance between the own vehicle and a preceding vehicle present in front of the own vehicle;
a deceleration control unit for performing deceleration control of the own vehicle with respect to the preceding vehicle based on the inter-vehicle distance detected by the inter-vehicle distance detection unit;
a branch path detection unit for detecting whether a branch path is present in front of the own vehicle;
an operation state acquisition unit for acquiring an operation state of a turn signal of the own vehicle; and
a steering state acquisition unit for acquiring a steering state of a steering wheel of the own vehicle operated by a driver of the own vehicle, wherein the deceleration control unit determines whether the driver intends to change a route to the branch path based on the operation state of the turn signal acquired by the operation state acquisition unit and the steering state of the steering wheel acquired by the steering state acquisition unit when the branch path detection unit detects that the branch path is present in front of the own vehicle while the deceleration control unit executes the deceleration control of the own vehicle with respect to the preceding vehicle, and terminates the deceleration control of the own vehicle with respect to the preceding vehicle when determination is made that the driver intends to change the route to the branch path.

2. The driving support device according to claim 1, wherein the deceleration control unit determines that the driver intends to change the route to the branch path when a direction indicated by the turn signal and a steering direction of the steering wheel are the same as a branch direction of the branch path.

3. The driving support device according to claim 2, wherein when a steering amount of the steering wheel is equal to or greater than a predetermined threshold value, the deceleration control unit determines that the driver intends to change the route to the branch path.
